(19) United States
(12) Patent Application Publication
(10) Pub. No.: US 2016/0307276 A1
(43) Pub. Date: Oct. 20, 2016

(54) SYSTEM AND METHOD FOR INSURING AGAINST UNRECOVERABLE LITIGATION COSTS

(71) Applicant: TIMOTHY J. YOUNG, NEW ORLEANS, LA (US)

(72) Inventor: TIMOTHY J. YOUNG, NEW ORLEANS, LA (US)

(21) Appl. No.: 15/133,794

(22) Filed: Apr. 20, 2016

Related U.S. Application Data
(63) Continuation-in-part of application No. PCT/US15/48560, filed on Sep. 4, 2015.
(60) Provisional application No. 62/149,764, filed on Apr. 20, 2015.
(60) Provisional application No. 62/175,508, filed on Jun. 15, 2015.

(51) Int. Cl. G06Q 40/08; G06Q 30/04; G06Q 50/18

(52) U.S. Cl. CPC G06Q 40/08; G06Q 50/182; G06Q 30/04

(57) ABSTRACT

The invention relates an indemnification policy or bond for expense reimbursement and reconciliation associated with litigation. For a premium paid for the policy or bond an insured would be assured of a specified recovery amount, provided at least a fixed percentage (e.g., an amount greater than 100%) had been advanced by a litigant or its attorney, towards cost and expenses in a litigation case, and that the amount advanced was unrecoverable out of litigation proceeds. In order to facilitate such an invention, an electronic system must also be incorporated to ensure a premium pricing model for the indemnification instruments, a sufficient means to exchange and generation of a contract or policy or bond between the insured and insurer, and a means for determining, which contracts are subject to a indemnification claim event, and ultimately a means of payment between the insured and insurer for claims made against a policy.

### CROSS-REFERENCE TO RELATED APPLICATIONS

This application is a continuation in part and claims priority under 35 U.S.C. §120 of international non provisional patent application, PCT/US15/48560, filed Sep. 4, 2015, entitled System And Method For Insuring Against Unrecoverable Litigation Costs, which claims the benefit of provisional patent application Ser. No. 62/102,652, filed on Jan. 13, 2015, and also claims the benefit under 35 U.S.C. §119(e) of U.S. provisional patent application Ser. No. 62/175,508, filed Jun. 15, 2015, entitled System And Method For Insuring Against Unrecoverable Litigation Costs, and the benefit under 35 U.S.C. §119(e) of U.S. provisional patent application Ser. No. 62/149,764, filed on Apr. 20, 2015, entitled Repayment Through Credit Swap of Non Recourse Loans Related To Litigation, and priority under 35 U.S.C. §119(e) of U.S. provisional patent application Ser. No. 62/102,652, filed on Jan. 13, 2015, entitled, Credit Default Swap And Electronic Trading System, For Protection Of Litigation Costs, the entire disclosures of each of the foregoing, which are hereby incorporated by reference.

### FIELD OF INVENTION

This invention relates to a data processing system and method based upon technology for reimbursement of costs and expenses incurred by a party to litigation.

### BACKGROUND

In the United States, attorneys or their law firms customarily advance various costs and expenses on behalf of client in the prosecution or defense of litigation cases. As a case proceeds to trial, an attorney generally accumulates greater and greater costs and expenses regarding the case. This creates a potential conflict between the attorney and his/her client because the amount of money at risk in the form of case expenses generally increases over time as the case proceeds to trial. The potential therefore exists where an attorney may often consult with the client and recommend a less than ideal settlement, particularly in cases where costs and expenses begin to meet or exceed case value estimates.

Controlling litigation costs is a problem for all parties in suit, including parties who are represented by an attorney designated to represent them pursuant to a commercial liability policy, for example. This is especially problematic in cases of certain commercial liability policies wherein the insured benefit is diminished as litigation costs increase. In such cases, pre-trial resolutions become increasingly more difficult as costs begin to meet or exceed case value because (a) client recovery may be minimal after the attorney's costs and/or expenses are repaid from the settlement proceeds; and/or (b) the attorney may have to write-off certain otherwise reimbursable costs and/or expenses to reach a settlement amount the client is willing to accept.

Another possible outcome is that cases that are otherwise properly brought, may be prematurely settled or terminated instead of being fully litigated. If the case cannot be settled due in whole or part because of rising litigation costs and/or expenses, a party may have no option other than proceeding to trial, thereby adding to financial burden.

If client desires to proceed to trial even in view of increased costs and expenses, the attorney is ethically bound to prosecute the case even if at its conclusion the attorney is caused to bear a monetary loss.

Another possible outcome is where one or more tribunals, including but not limited to judicial courts of law and/or equity, or governmental, quasi-governmental, private or public administrative bodies, boards, panels or agencies, that may be composed or comprised of one or more selected or appointed judges, mediators, arbitrators, elected officials, experts within the relevant field or members of the general public (or any combination thereof), renders a final decision or judgment in favor of a party on one or more counts presented in a request for relief, including but not limited to a complaint, counter-complaint, counterclaim, request for declaratory relief, but such decision is appealed by one of the litigants. In such circumstances, though final judgment is entered, the litigation may continue if an appeal is pursued, further increasing costs and expenses of client and its attorney. In such instances, an appeal may be filed by the party against whom judgment was entered or by the party who obtained judgment, but nonetheless asserts that error occurred during the litigation resulting by way of example and not by limitation, in a diminished recovery.

Another possible outcome is where a party may desire to pursue multiple legal theories, generally understood in the art as “claims” presented in “counts” that generally set forth the minimum legal and/or factual basis for asserting such claim before a tribunal. Depending on the nature of the harm to a complaining party, the type, quality and quantity of evidence required to prove each count may differ significantly. A party may be dissuaded based on his/her/its general knowledge and/or based on guidance from an attorney of likely or estimated litigation costs, from pursuing an otherwise viable claim but for the significant incremental cost for pursuing and proving such other claim. By way of example under similar or overlapping facts of a particular case, a party may elect to pursue only a claim for a breach of contract even where there also exists a viable claim of intellectual property infringement, based in part on litigation cost.

While many jurisdictions allow (and some even require) that the attorney make efforts to recoup the case expenses from client or its attorneys, in practice this can be difficult and often unfruitful for a variety of reasons, including insolvent client (in the case of many personal injury claims), and dissatisfied corporate client or its attorneys, who may be unwilling to re-pay costs for what they then view as a less than adequate representation, following a unfavorable outcome.

Over time, banks have extended credit to attorneys so that they can advance litigation expenses. The loans are essentially attached to the respective cases, which essentially provide the banks with a lien or priority to be repaid such loans out of any case proceeds. Yet the attorney still remains obligated, and often personally obligated, to repay such loans in the event of an unfavorable case outcome. While many attorneys have financial resources to repay such loans, often the repayment is discounted and spread over time, resulting in significant financial risk and exposure to the bank in the event of an unfavorable case outcome. Thus while the bank or lender in theory may seek recovery from the attorney or client or its attorney, in practice the bank or lender faces a claim risk in the event of an unfavorable case outcome.

Businesses that need a consistent way of keeping track of litigation costs have adopted a uniform task-based management system (UTBMS), such as the system proposed by the American Bar Association. See, http://www.americanbar.org/groups/litigation/resources/uniform_task_based_management_system/background_definitions_principles_and_assumptions.html. Within such system, a user may accept or adapt a recommended litigation code set to, among other things, track litigation costs. Until now, there has been no way to utilize a UTBMS, as a means for securing payment or reimbursement of litigation costs to a litigant directly, or to his or its counsel, either or both of whom may be an insured or subscriber to a program, that provides automatic payments by way of electronic data interchange when certain events or pre-conditions are met. Thus, this invention provides for the creation of a specialized indemnification obligation that will allow attorneys, banks and other institutions the ability to recoup all or a portion of their costs or expenses that may arise out of loans to support litigation costs and expenses.

### SUMMARY OF THE INVENTION

The invention herein relates to a system for automatic payments made to insureds of a policy providing automatic reimbursement of self-selected costs of litigation, upon the occurrence of certain pre-set conditions. Such litigation costs include, but are not limited to, government fees such as court costs, court reporter, videographer fees and expenses, witness fees, expert fees, document production costs, including compliance or conducting of e-discovery, preparation of exhibits, models, trial exhibits and similar displays or tools used in litigation, witness travel and preparation costs, costs relating to service of process, investigation or surveillance, and upon determination that the pre-set conditions are met, through one or more graphical user interfaces (GUI) and from a system capable of generating an automatic indication, based on comparisons to similar cases and/or a set scale of estimated costs, that a claimed amount is authorized to be paid, typically at the completion of a litigation, where an unappealed or unappealable judgment, or settlement that does not adequately cover costs and expenses (hereinafter “judgment” includes final judgment, or settlement) has been rendered. (Throughout, any reference to litigant, attorney, subscriber, user, indemnitee, customer and applicant has the same meaning), resulting in an automatic payment to the insured or subscriber by electronic data interchange.

The invention relates to a system for processing data relating to insuring against litigation expenses including: (a) at least one computer processor; at least one memory; and computer program code stored in a computer readable storage medium executable by the at least one processor, having a graphical user interface configured to administer an indemnification contract related to one or more litigation cases; (b) a first storage device for storing a database that contains a plurality of indemnification contracts associated with one or more litigation cases; (c) a second storage device that contains a status of the one or more litigation databases of cases before state and federal courts; (d) a web crawler that searches the litigation databases to update a data input technology that monitors the one or more litigation cases before one or more state and federal courts; (e) wherein the database litigation technology produces an electronic indicator signal if a change in the litigation case status occurs; and (f) a comparator compares the database litigation case that produced the electronic indicator signal, to a litigant contracts database containing a related litigation case, such that if the comparison matches then, the comparator stores a flag in a register, which flag is read by the processor that executes computer code to test if an insured is entitled to a sum of money equivalent to the value of an insured interest.

In one embodiment, a premium paid by a litigant or its attorney for an indemnification contract, policy or bond, would assure a specified recovery amount, provided at least a fixed percentage (e.g., an amount greater than 100%) had been advanced by litigant or its attorney over and above the premium, towards costs and expenses in a lawsuit, and that the amount advanced was unrecoverable out of litigation proceeds or the litigation proceeds were insufficient to cover the actual litigation costs and expenses advanced or paid by litigant or its attorney.

In certain types of litigation, for example, in class action lawsuits or patent infringement lawsuits, the projected cost and expense of litigation may exceed the insurer's or indemnitor's willingness or ability to underwrite the entire projected risk, which may then result in the generation of multiple indemnification contracts or bonds, or an instrument in which all or a portion of such risks are “pooled” in order to spread the risk among multiple insurer's or indemnitors. In another embodiment, the system notifies each participating insurer or indemnitor or pooled risk administrator if payment is due.

In order to facilitate the foregoing method an electronic system incorporates a sufficient means to provide data to populate a premium pricing model for the indemnification instruments, generate one or more indemnification contracts or bonds between one or more an indemnitees and indemnitors, and a means for determining, which contracts are subject to an indemnification claim event, and ultimately a means of determining, if a payment is due and if a payment is due under a contract, the amount of payment between the indemnitee and the indemnitor for claims made against the contract.

One embodiment of the present invention relates to a method of insuring against litigation expenses of a litigation comprises the steps of (a) guiding a user through a series of graphical user interface queries to supply information to a database, including by way of example: the identity of the insured, type of litigation case, a requested amount of indemnity sought, a range of economic damages, name of carrier, type of coverage; (b) storing the information in a database; (c) using the information to calculate a cost of indemnification coverage; (d) using the cost of the indemnification coverage to calculate a premium to be paid for the indemnification coverage; (e) creating an indemnification policy based upon risk factors; (e) monitoring the progress of the litigation utilizing a web crawler; (f) determining if the litigation reaches final judgment by comparing documents retrieved by the crawler; (g) paying the insured an amount of money dependent on the indemnification policy.

The information provided by a user and stored in one or more of the databases includes such information as: entity or personal information about the litigant, such as by way of example, an individual's name, age, social security number, the precise type of case, for example, contract, negligence, tort, and in some instances more specifically the cause of action includes, whether personal injury, wrongful death, premises liability, intellectual property infringement, followed by a range of economic direct damages (e.g., property damage, medical costs, reputation damage), a statement of other damages, for example, punitive damages or whether the applicant is seeking attorneys fees, and if so on what basis, for example, by statute and/or contractual. The user is then guided through a series of GUI queries and responses, which allow the applicant to change, modify or adjust the information which at the end of the application process provides a non-binding or binding estimated cost of indemnification coverage within an insurer-specified plus/minus cost variance for a period of time. Another aspect of the GUI may allow the applicant to select a rate-lock for a specified period of time, generally at an increasing cost as the rate-lock period increases.

Another embodiment of the invention relates to a computer method for issuing at least one of a surety bond for an expense reimbursement and reconciliation process tied to litigation cost loans. A premium paid for the bond would indemnify the insured at least a specified recovery amount, provided at least a fixed percentage (e.g., an amount greater than 100%) had been advanced over and above the premium, by an attorney, towards cost and expenses in a particular litigation case, and the amount advanced was unrecoverable, in whole or in part, out of the litigation proceeds or the litigation proceeds were insufficient to cover the actual litigation costs and expenses advanced or paid by litigant or its attorney. The process of issuing the bond includes: automatically storing underwriting data so as to be accessible by at least one computer processor; storing data indicative of at least one surety bond customer, such as an attorney, other indemnitee, such as a lending bank, or a litigant so as to be accessible by said at least one computer processor; inputting data indicative of at least one surety bond to be issued and being associated with one of said bond customers; automatically calculating a premium for at least one surety bond to be issued based on the input data and the underwriting data in response to a request therefor; storing data indicative of images of a plurality of pre-defined bond forms so as to be accessible by said at least one computer processor; selecting a sub-set of the data indicative of images of a plurality of pre-defined bond forms, dependently upon the inputted data; and automatically rendering the at least one surety bond to be issued using said data indicative of bond customers, the selected data indicative of images of a plurality of pre-defined forms, and calculated premium in response to a request therefor, at least to cover a fixed percentage (e.g., an amount greater than 100%) advanced over and above the premium, by a customer, towards cost and expenses in a particular litigation case, and wherein the amount advanced was unrecoverable out of the litigation proceeds; and wherein data indicative of said indemnification underwriting instrument is automatically stored so as to be accessible to said at least one computer processor.

In one embodiment of the invention, the indemnification policy or a surety bond is purchased by a law firm for the protection against uncollectible litigation costs that an attorney and/or the attorney's client or its attorney may be subject. For example, indemnification policy documents are automatically created when a client or its attorney relationship is formed with the attorney, thorough a series of GUI screens accepting input data. The purchase of the policy or bond will be authorized by the client or its attorney, and the cost of the policy will be added to the cost of litigation. The computer interface may also allow for the purchasing attorney to view all current and past indemnification policies or surety bonds the attorney or law firm has purchased details of such instruments, and the status of same.

In one embodiment of the invention, an indemnitee bank, which lends funds for litigation expenses, may, pursuant to providing the client or its attorney and attorney with claim, also automatically, through a computer interface, such as a GUI purchase an indemnification policy to guarantee repayment, in the event the client or its attorney does not have sufficient award proceeds to pay back the bank loan used to finance the litigation costs.

In another embodiment of the invention, the customer may purchase the indemnification policy or bond from an indemnification company, provided any requirements of the federal or state regulations, including regulating bar associations are met. Such embodiments would protect the attorney's personal assets from being exposed to collection efforts by those who may have outstanding bills for services rendered during litigation of the case, provided that at least a specified recovery amount was less than or equal to at least a fixed percentage (e.g., an amount greater than 100%) having been advanced over and above the premium, by an attorney, towards cost and expenses in a particular litigation case, and the amount advanced was unrecoverable out of the litigation proceeds or the litigation proceeds were insufficient to cover the actual litigation costs and expenses advanced or paid by litigant or its attorney.

Additionally, the invention provides a means for estimating and setting proper reserves, a means to value and sell off future possible claims on ongoing policies.

Another embodiment of the invention is a computer method that protects against the risk of financial losses of case expense, i.e., costs in litigation, including: (a) using a computer processor for executing computer code to create an indemnification contract; (b) using a computer processor for executing computer code to request an insured participant to provide a premium payment to the insurer in exchange for the contingency payment triggered by the occurrence of the claim event (c) using a computer processor for executing computer code to determine if a claim is supported by indemnification and thereby establish a right of reimbursement of litigation costs, not satisfied by a favorable judgment in a case; (d) using a computer processor for executing computer code to transfer to the insured a sum of money equivalent to the value of the insured interest, in order to pay for outstanding litigation expenses.

In yet another embodiment of the invention a computer program includes an interface embodied on a computer program includes an interface embodied on a computer readable medium for protecting against the risk of financial losses of case expense costs in litigation of a customer further including: an automatically generated electronic indicator comprised of web crawler that interfaces and updates the system, and provides other subsystems with information, such as documentation to electronically indicate the termination of a litigation for reimbursing otherwise unrecoverable litigation costs.

In yet another embodiment of the invention, a GUI can be used by the purchasing party to upload necessary documents in the underwriting process including such documents as attorney/client contract, filed lawsuit, and authorization from client for purchase of the instrument. Similarly, documents can also be uploaded during the payment process for any policies, bonds or instruments upon which payment may be due to the purchaser. All such documents could be stored on a central server and accessed by parties in the transaction.

### BRIEF DESCRIPTION OF THE DRAWINGS

FIG. 1 is a block diagram of a system for creating, exchanging, determining the value of, and settlement of an indemnification policy or bond, in accordance an embodiment of the present invention;

FIG. 2A represents a flowchart illustrating the method of creating, exchanging, determining the value of, and settlement of, the indemnification contract or bond, in accordance an embodiment of the present invention;

FIG. 2B represents a continuation of the flowchart, FIG. 2A, illustrating the method of creating, exchanging, determining the value of, and settlement of, the indemnification contract or bond, in accordance an embodiment of the present invention;

FIG. 3 is a block diagram of a system for web crawling, triggering documents material to a determination of case judgment or settlement, determining the value of, and settlement of an indemnification policy or bond, in accordance an embodiment of the present invention;

FIG. 4 is a block diagram of a system interface for creating, exchanging, determining the value of, and settlement of an indemnification policy or bond, in accordance an embodiment of the present invention;

FIG. 5A shows a screen for inputting data into the invention system in accordance with an embodiment of the present invention;

FIG. 5B shows a screen for inputting data into the invention system in accordance with an embodiment of the present invention.

### DETAILED DESCRIPTION OF THE INVENTION

In the figures to be discussed, the blocks and arrows represent functions of the process according to embodiments of the present invention, which may be implemented as computers, computer executable code, and/or electrical circuits and associated wires or data buses, which transport electrical signals. Alternatively, one or more associated arrows may represent communication (e.g., data flow) between or among software routines, particularly when the present method or apparatus of the present invention is implemented as a digital process.

An indemnification, policy or bond, include terms of art. These terms include among other things, what triggers or constitutes the ‘claim event’ or ‘reference event’ (hereinafter ‘claim event’ for consistency), the ‘claim exposure’, ‘valuation metrics’ and ‘maturity’. The claim event is the specified event, which triggers the obligation of the protection insurer or insurer to pay the protection to the indemnitee or insured under the indemnity or indemnification contract. The claim exposure is the amount of risk undertaken by the insurer. In the invention herein disclosed, a specified recovery amount is at least less than or equal to a fixed percentage (e.g., an amount greater than 100%) that is advanced over and above the premium, by an attorney towards cost and expenses in a particular litigation case, and wherein the amount advanced is unrecoverable, in whole or in part, from the litigation proceeds.

Maturity is defined as when the claim event occurs or when the underlying case is terminated through a full dismissal of all future legal redress, without the occurrence of a claim event, whichever occurs first.

Under one embodiment of the invention, the claim event is the entry of a final judgment in favor of a party on one or more counts in the case and dismissal of the case with prejudice and with all appeals exhausted or from which no timely appeal has been made. The policy or bond contract does not come into existence unless and until the client or its attorney provides a certified copy of the order of dismissal with prejudice. This is a condition precedent for each contract under such embodiment. Under this embodiment, the claim exposure is equal to the deficiency that exists (if any) between final recovery, after payment of attorneys fees, and that portion of the case expenses which are not able to be repaid out of the case proceeds, if any, limited to a maximum claim exposure amount equal to the full sum of the underlying loans or notes on said case. Under this embodiment, once the condition precedent has been satisfied, a claim will be paid in accordance with the contract terms. Under an alternate embodiment herein, even if the condition precedent has been satisfied, any amounts otherwise due to be paid under the contract will be reduced or set off by any amounts paid by an adverse party by way of settlement.

Under another embodiment of the invention, the claim event is the later of entry of a final judgment (which may include a settlement) in favor of a party on one or more counts in the case and dismissal of the case with prejudice and with all appeals exhausted, or from which no timely appeal has been made, or the entry of a final judgment in favor of a party on one or more counts in the case, and dismissal of the case with prejudice without exhaustion of all appeals, by way of example, where all parties to the case or relevant claim or count as the case may be, to voluntarily stipulate to entry of final judgment. Under another embodiment, a policy or bond contract may be obtained on varying phases of litigation. By way of example and not limitation, the parties to a policy or bond contract may execute one or more agreements for reimbursement relating to costs and expenses through the trial phase, but such agreement does not extend to appeals; or where the terms of the policy or bond contract provides for partial reimbursement where final judgment is obtained as to some but not all counts or claims. Under this embodiment, a condition precedent for each contract is a certified copy of the order of dismissal with prejudice or a certified copy of the order of dismissal with prejudice and a certified copy of a notice of appeal pertaining to at least one issue in the case. In one this embodiment the claim exposure is equal to the deficiency that exists (if any) between final recovery following the final disposition of the case whether by final dismissal of the case with prejudice or dismissal of the case after exhaustion of all appeals, after payment of attorneys fees, and that portion of the case expenses which are not able to be repaid out of the case proceeds, if any, limited to a maximum claim exposure amount equal to the full sum of the underlying loans or notes on said case. The obligation of payment under such policy or bond contract does not come into existence unless and until the client, its attorney or an automatically generated electronic indicator provides a certified copy of the order of dismissal with prejudice. This is a condition precedent for each contract under such embodiment.

Under yet another embodiment, the claim exposure is equal to the deficiency that exists (if any) between final recovery, after payment of attorneys fees, and that portion of the case expenses which are not able to be repaid out of the case proceeds, if any, limited to a maximum claim exposure amount equal to the full sum of the underlying loans or notes on said case. Under this embodiment, once the condition precedent has been satisfied, a claim will be paid in accordance with the contract terms. Under an alternate embodiment herein, even if the condition precedent has been satisfied, any amounts otherwise due to be paid under the contract will be reduced or set off by any amounts paid by an adverse party by way of settlement.

As is common with many indemnification policy or bond instruments, the claim event is not the same as the claim exposure. In this invention, the event is the finality of the litigation with less than adequate recovery to shield the protected insured from a financial loss. While the claim event may ultimately result in the protected insured suffering a financial loss, it does not always follow that such will occur, as in when the client or its attorney are able and willing to make repayment of the case litigation costs and expenses.

Under one embodiment of the invention, in the event of a claim event, and the insurer owes the insured the protection sought, such payment would not be due until the presentation of the claim for settlement. And, under a further embodiment, the insured is required to present all documents supporting such claim and if applicable, documents relating to settlement with an adverse party, within a set period, say 30 days, of date giving rise to the event. This allows the insurer to maintain knowledge of total settlements sought at any one time.

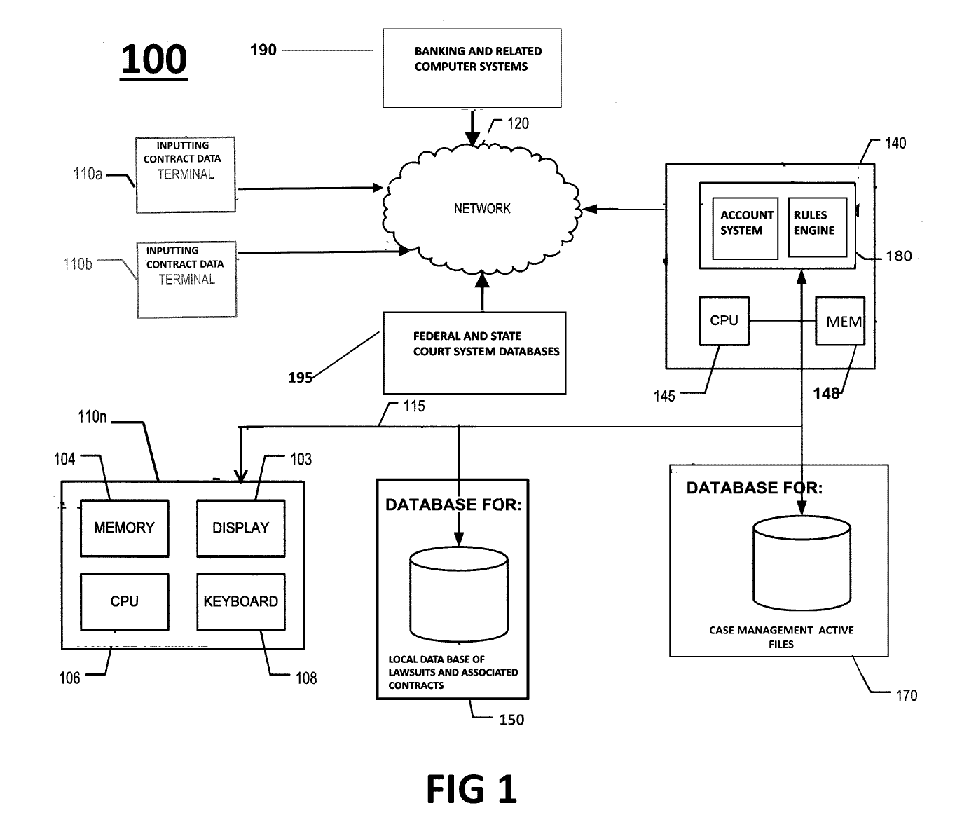

Referring to FIG. 1, the invention includes a system for underwriting, quoting, policy or bond generation and binding, to mitigate the financial consequences of certain economic losses. It will be understood that FIG. 1 illustrates an exemplary embodiment of a system 100 used for implementing the principles of the present invention. In general, the system includes a local area network of terminals or workstations, database file servers, input devices and output devices configured by software for accumulating, processing, administering and analyzing indemnification in an automated workflow environment. The system provides for on-line quoting, rating, and binding of policies or bonds, electronic data transfer and the evaluation and access to the data relevant to technology pertinent to reducing costs associated with certain avoidable hazards and losses.

The system 100 also provides for storing data indicative of images of a plurality of pre-defined bond forms so as to be accessible by said at least one computer processor; selecting a sub-set of the data indicative of images of a plurality of pre-defined bond forms, dependently upon the inputted data; and automatically rendering at least one surety bond to be issued using said data indicative of bond customers.

One embodiment of the invention, such as described in FIG. 1, facilitates the creation of and the subsequent purchase of an indemnification policy or bond, as well as payment in satisfaction of such policy or bond. Using computer system 100, an indemnification company or carrier logs into terminal 110n, to administrate and manage the indemnification contracts related to indemnifying claims against unpaid expenses accrued during litigation, and to view and manipulate data related to the contracts, such as case identifiers, parties, litigation types, claims, claim types and claim categories. Terminal 110n contains a memory 104, display 103, CPU 106 and a keyboard 108. Computer system 100 also permits potential policy or bond holders or insureds to log into input devices (not shown) to remotely, e.g., via the Internet, solicit an indemnification policy or bond from an indemnification provider, where the indemnification provider operates system 100. The indemnification provider may include, but is not limited to, underwriters, carriers, insurers, reinsurers, brokers, banks, other lenders and/or agent (collectively, “carrier”). These terminals also have features for correspondence between the insured and the carrier, and to permit each to view indemnification contracts they may have in place.

Additionally, the system 100 allows each potential insured, via remote terminals (not shown) to request a premium quote for a policy or bond, dependent on key factors such as the type of litigation, the relative strength of the case that supports recovery, the experience of the attorneys, the amount of money sought through litigation. Further it allows each potential insured to input data, such that the premium quote may be generated automatically, with such data including the underlying case reference, against which the notional value (or maximum payout value) is sought.

The system 100 allows for the automatic computer generation of the contract premium referenced by considering certain data as processed by underwriters. Additionally, an indemnification company may, decline to accept a risk or increase its premiums for certain risks, based on the total notional value of all outstanding potential indemnification claims, the estimated maturity dates for all such contracts, and on certain assumptions, as to the time period of potential liability for each contract, and the historical claim event occurrence rate.

System 100 further allows for the generation of invoices for the payment to potential insureds upon the occurrence of claim events. It further allows for the uploading of all required documentation including case documentation, such as complaints and original filings, and confirmations of each indemnification policy or bond, which are executed by the insured and insurer, by pulling data from the system including the potential insured's information, the case reference subject to the contract, the input notional value of the contract and the automatically calculated premium for such contract.

System 100 further allows for the storing data indicative of images of a plurality of pre-defined bond forms so as to be accessible by said at least one computer processor; selecting a sub-set of the data indicative of images of a plurality of pre-defined bond forms, dependently upon the inputted data; and automatically rendering the at least one surety bond to be issued using said data indicative of bond customers, and printing key documentation underlying all contracts by both insured and insurer dependent on at least a specified recovery amount less than or equal to at least a fixed percentage (e.g., an amount greater than 100%) having been advanced by a customer, towards cost and expenses in a particular litigation case, and the amount advanced was unrecoverable out of the litigation proceeds or the litigation proceeds were insufficient to cover the actual litigation costs and expenses advanced or paid by litigant or its attorney.

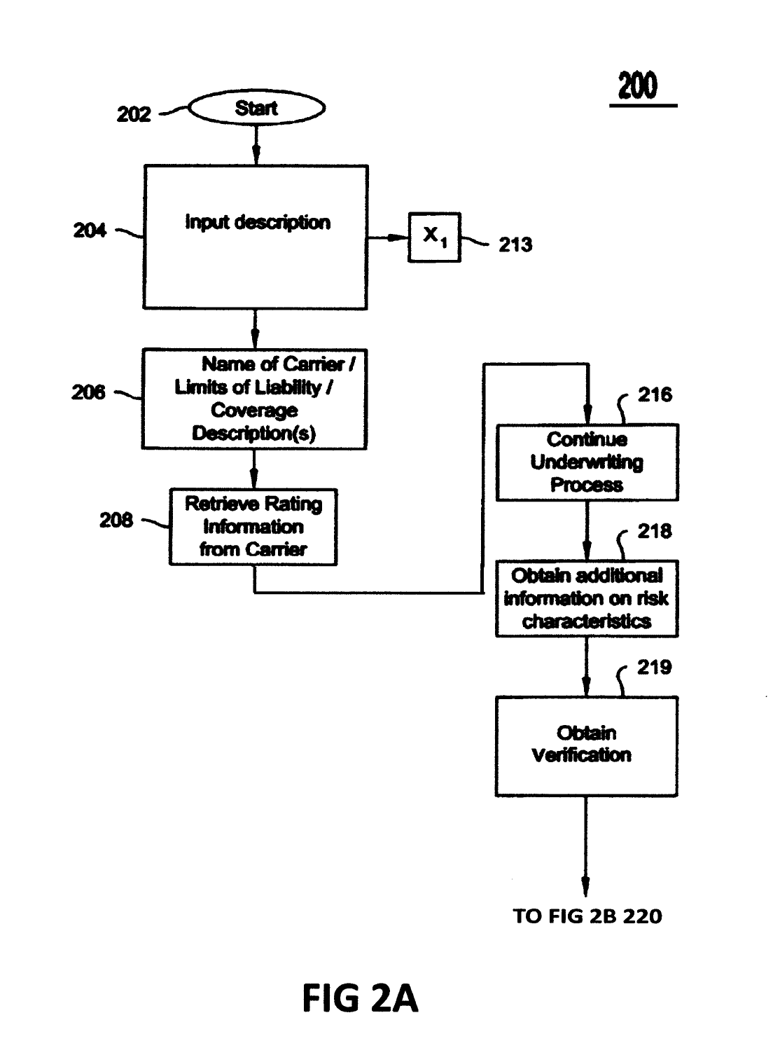

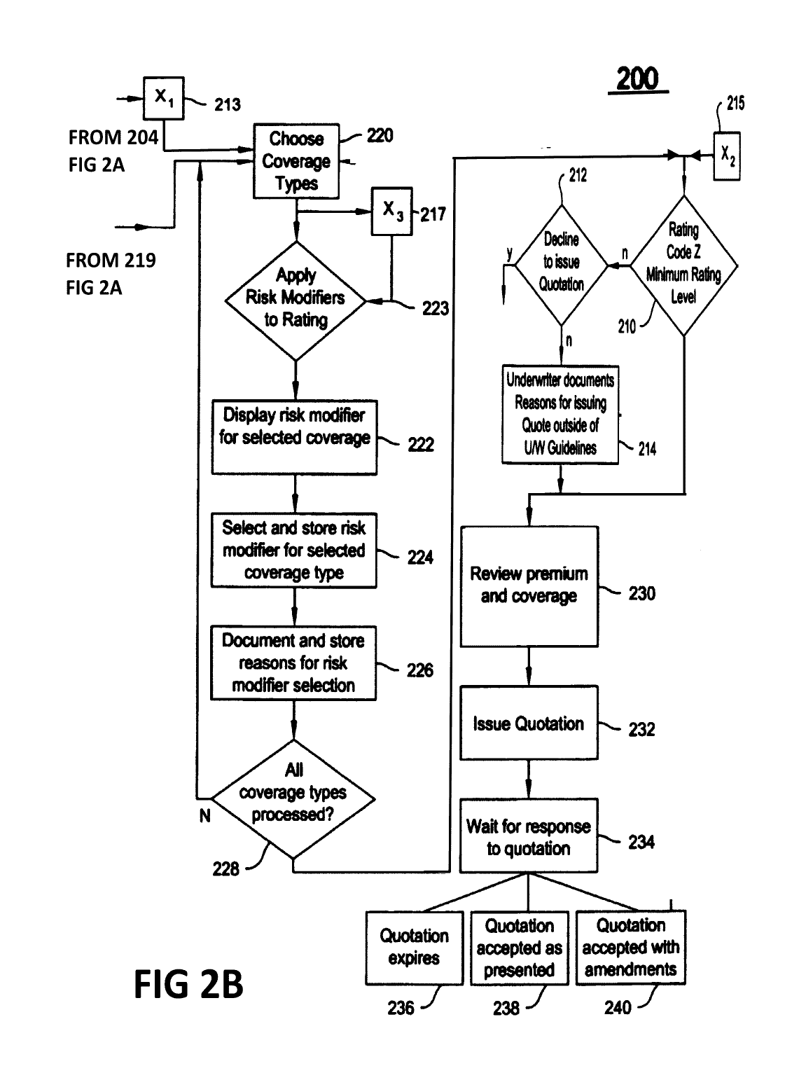

More particularly, system 100 includes the one or more terminal 110n, each having a corresponding CPU, such as CPU 106, which includes a display 103 and memory 104. The terminal 110n are used for underwriting, creating, selling and managing policies and bonds, the issuance and premium of which is based upon the insurable interest. In addition, a database means 150 is interconnected to the terminal 110n for storing predetermined rate data; output means 160 for producing documents in at least one of text, graphics, and electronic transfer mode, said output means being interconnected and responsive to each of said plurality of terminal means such as terminal means 110n; and, a corresponding input means keyboard 108 for receiving predetermined input into the CPU 106, and a program means 190 for configuring each of said plurality of terminal 110n and undertaking to execute process 200 (see, FIG. 2A and FIG. 2B).

Input source 115 also communicates with one or more network connections for receiving data from a server 140 over network 120, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

Other servers 140, may be in communication with network 120 or may be in direct communication with terminal 110n or remote input terminals (not shown). Server 140 and terminal 110n are in communication with database means 170 to obtain rate information, to store information related to hazard ratings and for any suitable purpose in underwriting, creating, selling and managing indemnification policies, the issuance and premium of which, is based upon the technology utilized in connection with the insurable interest or the publication of the quantitative effects a single or a plurality of factors relevant to a litigation outcome have upon the underwriting process, and based upon generic inquiries specifying a range of variables related to the factors incorporated into the data stored on the database means 170.

In addition to on-site databases, such as database means 150 and a remote data base means 170, data may be provided from a data provider 180.

In a preferred embodiment, computer readable code executed by CPU 106 and memory 104 as processing relates to terminal 110n may implement the coding and decoding employing the principles of the present invention. Correspondingly, computer readable code executed by server 140 as processing relates to CPU 145 and memory 148 may implement the coding and decoding employing the principles of the present invention. In other embodiments, hardware circuitry may be used in place of, or in combination with, software instructions to implement the invention. For example, the elements illustrated herein may also be implemented as discrete hardware elements. Therefore, terminal 110n, remote input terminals (not shown) and server 140 may be also, yet not exclusively, embodied in such means as a general purpose computer or a special purpose computing system, such as a dedicated logic circuit, integrated circuit, programmable array logic (PAL), application specific integrated circuit (ASIC), that provides known outputs in response to known inputs.

Referring to FIG. 2A and FIG. 2B, which illustrate the operation of a computer-implemented software process 200 for underwriting, quoting, binding, issuing and managing policies and bonds, by an indemnification underwriter dependent on a plurality of factors relevant to a litigation outcome. Software process 200 is preferably implemented on a workstation typical of the terminal 110n such as illustrated in FIG. 1. In the present instance, the system 100 allows users to access process 200 to perform underwriting functions; quote policy or bond coverages and premiums for indemnification policies locally and from remote locations.

The following description refers to a system for the generation of a surety or commercial property and casualty lines of indemnification for the quantitative effects a single or a plurality of factors relevant to a litigation outcome. In referring to FIG. 1 and FIG. 2A, FIG. 2B in a first step 202, through an input device 108, a user logs into process 200 through an associated terminal 110n having a display 103, that connects to a means 150, providing first and second data bases. In the next step 204, utilizing the input device 108, the customer enters information for whom indemnification is sought, dependent upon the outcome of litigation. Such information typically includes, the name, address, telephone number of the insured party, the date a request for the quotation, a description of the insured's factors relevant to a litigation outcome.

The system 100 and associated software process 200 maintain several means for storing databases such as storage devices 150 and 170. As will be apparent to those skilled in the art of programming the specific storage of databases utilized by the system 100 will present a design choice for the programmer. The description that follows may call out a database means attached to a user terminals, remote terminals or such as terminal 110n, but such database means, as device 170 attached to server 140 would also fall within the spirit of the inventions in any instance where a database were required.

The process 200 displays, on display 103, a plurality of candidate risk modifiers, such as may be retrieved at points in the process, as by way of example, risk modifier 213, 215 or 217, each associated with one or more factors that mitigate the risk of loss associated with the insurable interest, such as the parties to litigation, the cause of action, the difficulty associated with case prosecution. Step 204 records a selected risk modifier code 213 and related underwriting criteria associated with the litigation risk and associated policy or bond.

The customer also enters the name of the carrier, in step 204, as well as the coverage type and limits of the indemnification policy or bond it seeks.

In step 206, the indemnification policy or bond producer responds and based upon the earlier description of the case. Since the underlying indemnification policy or bond may have separate limits for general recovery and specifically named recovery coverages, such as when the litigant expenditures exceed certain limitations, the indemnification policy or bond producer may enter separate primary coverage limits in this step. Step 206 also includes the carrier's expiration dates of the proposed indemnification or bond contract limitations, if any, on the causes of action that may be insured.

The present invention maintains in database 150 information relating to the potentially insurable risk. In step 208, the process 200 retrieves from a first database resident in storage device 150, rating information, which is developed by the named indemnification carrier based on claims' experience.

In step 216, the system retrieves and displays underwriting guidelines associated with the type of legal cause of action that was previously entered in step 204. The present invention maintains a database residing on storage device 150, which contains underwriting instructions and guidelines, including minimum premiums, corresponding to each type cause of action that a customer might enter into the system in step 204.

The rating instructions contain factors that are considered when associating a risk to a particular cause of action. Based on this rating information, the underwriter selects one or more ratings for the quotation in step 218. The selected rating(s) are then stored in the process 200 storage device 150 as part of the computer file associated with the particular quotation. In step 219, the user may obtain a verification of the factors used in determining coverage for the insurable interest under consideration.

In step 220, the user chooses one or more of the coverage types which are applicable to the policy or bond, dependent upon the specific factors of the legal case being considered in the quote. Thus, for example, if the policy or bond being quoted includes coverage for an automobile accident case, the system would display 222 a range of risk modifiers 223 for the selected coverage. By way of an further example, an environmental claim would yield a different set of risk modifiers 223 in relation to a base or average risk for a given classification. In the present invention, by way of example and not limitation, the base risk may have two components, a first specific risk, historically associated with a type of cause of action, and a second specific risk that adjusts the first risk dependent on the complexity of the particular case, such as the extent of injury or damages, or the difficulty in proving liability. The risk modifiers 223 are the result of the classification 217 of the various causes of action that a carrier may consider. In steps 224 the user selects one of the predetermined risk modifiers for the selected coverage, and then documents 226 the reasons (e.g., standard cause of action or non-standard, involving by way of example multiple potentially liable parties) for the specific risk modifier that the user selected. In step 228, the process may be repeated for each type of coverage dependent upon number or different causes of action to be included as part of the quotation.

In step 210, the rating quoted is compared against a predetermined minimum indemnification-rating threshold 210 established by the carrier that issues the premium quotation. The process 200 takes into account the risk modification step 215, where a risk modifier code factors into the decision, such as the strength of the litigants case, the experience other like-claims have had relative to success or failure to yield a successful litigation outcome, the amounts of past judgments, rating of the firms involved in the litigation, ratings associated with the judges in particular cases, among other factors that the indemnification company might deem pertinent in affecting the outcome. If, as a result of this comparison, the system determines that the rating of the indemnification carrier is below the predetermined threshold, the system proceeds to step 212, where the indemnification underwriter is given the option to decline to issue a quotation or refer the submission to a managing authority for further consideration. If the underwriter declines to issue the quotation in step 212, then the system optionally generates a declination letter, indicating that no quote will be submitted for the policy or bond; otherwise, the system proceeds to step 214 where the underwriter is typically required to document reasons for writing coverage that does not meet minimum normal criteria.

In step 230, the system generates premium amounts associated with the cause of action input in step 204, the rating code(s) selected in step 218, and the risk modifiers selected in steps 223 and 224, 213, 215, 217 respectively. In a preferred embodiment, the premium amounts generated in step 230 are accessed from a table stored on the process 200 database device 150.

Next, in step 232, the carrier issues the premium quotation generated in step 230, and a policy or bond description. The quotation is then communicated to the customer, i.e., the insured.

After the quotation is issued in step 232, the system awaits 234 a response to the quotation. In the event that the quotation is accepted, the system proceeds to step 238 where the policy or bond is thereafter bound. In the event a quotation 232 is not received in a time specified in the quotation, the offer expires 236. The quotation may also be accepted with proposed amendment 240, which is there upon resubmitted via step 220 to re-quote the premium.

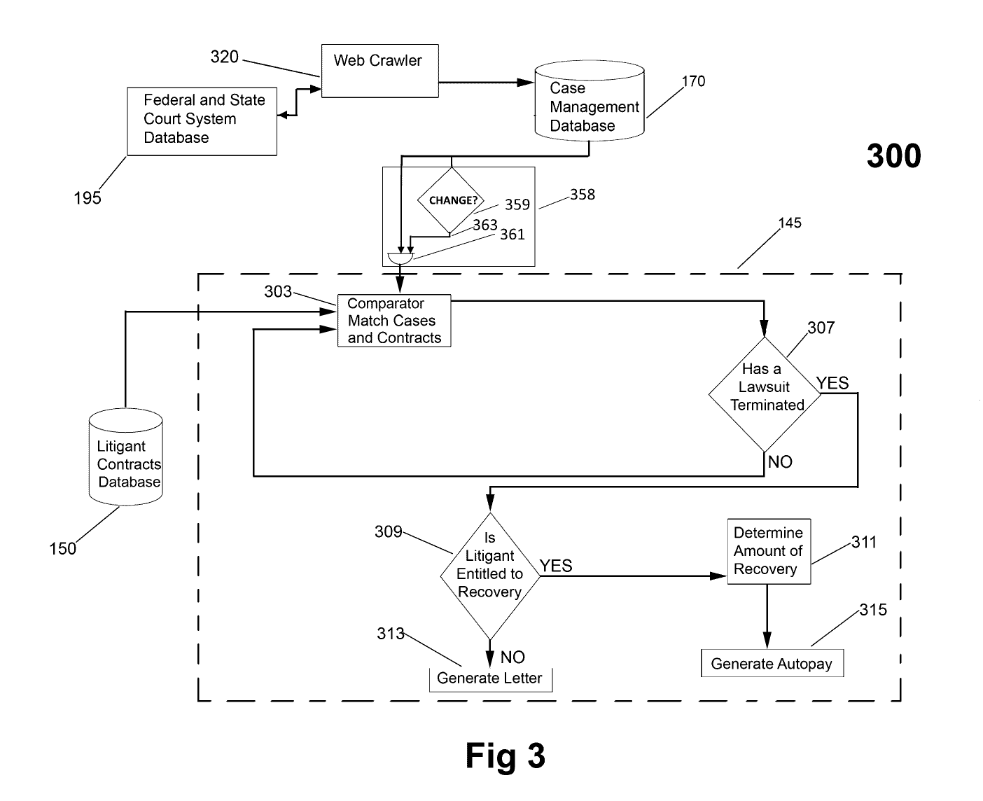

FIG. 3 represents a non limiting embodiment of the present invention that relates to a system 300 for processing data relating to reimbursing litigation expenses. The first storage device 150 stores a database that contains a plurality of indemnification contracts associated with on-going litigation. A computer processor, such as FIG. 1, server 140 as processing relates to CPU 145 and memory 148, in one embodiment, implements coding and decoding employing the principles of the present invention, when configured to: administer a contract, such as a policy, and data related to reimbursement expenses for the on-going litigation. The second storage device 170 stores a database that contains the status of active litigation cases before state and federal courts database, where the status updated by a data input technology, such as a web crawler 320. The input technology interrogates a plurality of distributed databases 195 that monitors litigation cases before state and federal courts and sends that information to case management database 170, to keep the database updated. A data input technology 358 determines if the latest update case management database storage device 170, has changed from the previous update. And if there is a change, then the particular data under review in database 170 is transmitted to comparator 303, which compares the first database 150 information, i.e., one of the cases in database 150, to the status of that case in database 170. If the status indicates that the case has terminated (i.e., entry of final judgment), then the system determines if a payment for litigation expenses is due.

More particularly, FIG. 3 illustrates computer system 300 that determines, based on a repository of litigant contracts in database 150, and subsequent data from a litigation website such as PACER, whether a case has reached a final disposition and if so whether a recovery of litigation expenses is due. The files of litigant contracts 150, which contingently reimburse for litigation expenses, are assembled from the contract data and other information generated, as per FIG. 2A and FIG. 2B.

In one non limiting embodiment, the web crawler 320 crawls one or more litigation websites for the litigation cases associated with litigation cases stored in the litigation contracts databases. Upon retrieving a case document, system 300 applies a test (see, reference number 358) against documents previously stored in case management database 170. This second depth testing based on the identification information, either results in system 300 to reject the document, finding no change in a parameter of interest has occurred, in which case the system 300 continues searching, or it determine that there has been a change, by electronically indicating that a comparison be made between the document and a litigation document stored in database 150.

The web crawler 320 starts with a list of URLs to visit, called the seeds. Crawl and search software 320 may also provide the crawled content and associated metadata (such as URL of the content, type of page, time of crawl, and so forth). As the crawler visits these URLs, it identifies all the hyperlinks in the page and adds them to the list of URLs to visit, called the crawl frontier. URLs from the frontier are recursively visited according to a set of policies. If the crawler is performing archiving of websites it copies and saves the information as it goes. The archives are usually stored in a database, such as case management database 170, in such a way they can be viewed, read and navigated as they were on the live web, but are preserved as ‘snapshots’.

The crawler 320 disclosed herein crawls databases such as PACER. Because most judicially created papers are published in PDF formats, such kind of crawler is particularly interested in crawling PDF, PostScript. Identifying whether these documents are legally related to a judgment or not is challenging and can add a significant overhead to the crawling process, so this may be performed as a post crawling process using machine learning or regular expression algorithms. Other legally related crawlers may download plain text and HTML files, that contains metadata of legal documents, such as motions, decisions and judgment of the court.

Turning back to the web crawler 320; it searches various databases that service and retain information concerning ongoing litigation, as indicated by way of example, PACER state and local litigation databases, for the parameters of an outstanding lawsuit. Such parameters include by way of example and not limitation, litigants, type of case, date of service, litigation scheduling, motions, and dispositions including judgments and damage awards if any. Types of systems are the Federal Judiciary Case Management/Electronic Case Files (CM/ECF) system, and the related PACER (acronym for Public Access to Court Electronic Records) system. PACER is an electronic public access service of United States federal court documents. (See, http://pacer.psc.uscourts.gov/).

Pacer allows users to obtain case and docket information from the United States district courts, United States courts of appeals, and United States bankruptcy courts. The system is managed by the Administrative Office of the United States Courts in accordance with the policies of the Judicial Conference, headed by the Chief Justice of the United States. As of 2013, it holds more than 500 million documents. Other non-profit projects have begun to make such documents available online for free. These systems update the system 300 or system 100, federal and state court database 195 and/or the case management database 150.

A database litigation technology 358 produces an electronic indicator signal 363, if a change in the litigation case status occurs, as determined by document comparator subsystem 359. This signal 363 the allow through logic circuit 361, a comparator to compare the database litigation case documents residing in case management database 170, that produced the electronic indicator signal, to a litigant contracts database 150; such that if the comparison matches then, in one embodiment, the comparator stores a flag in a register, which flag is inspected (i.e., logically tested) by a processor that executes the function described in functional block 307, via hardware or computer code, and if the lawsuit has terminated, then to indicate that the insured is entitled to a sum of money equivalent to the value of the insured interest. Essentially the hardware signal or executable code determines if the litigation case has terminated and if a payment under the contract terms and conditions of a contingency payment related to a litigation is due.

The database litigation technology 358, automatically generated electronic indicator 363 of a change in case status received by the case management database 150 litigation file, and comparator may be provided an Application Specific Integrated Circuit (ASIC), that provides known outputs in response to known inputs to provide among other things, for the electronically triggered by the occurrence of a status change in the case.

The related files in database 170 as processed by the database litigation technology 358 and the subsequent related files resident in litigant contracts database, when compared in comparator 303, may in one embodiment use machine learning or regular expression algorithms, to produce the various signals and outcomes described herein.

The data input technology 358 interface receives data from the case management database 170, from which the data input technology 358 interface determines if a case status has changed, and if the case status has changed, it then initiates a signal that allows the new data (typically a file or paper generated by the court) to be compared via the comparator 303 (see, FIG. 3) to litigants contracts 150 to determine if the new data pertains to a litigant contract of interest, as previously described. Thereafter via decision block 307, the process determining if the case achieved a judgment, and may be ready for a payout.

As stated above, when a status change has occurred, it is compared to cases on file, and if signaled by comparator 303, then test 307 determines if the case status change denotes that the case has terminated, in accordance with the litigant contracts in database 150, which under the conditions of the contract contingently reimburse for litigation expenses. If the case has not terminated then the comparator 303 reverts to a wait state, that is, continues to seek a status change to the cases in database 170. If a case has terminated, as determined by block 307, then block 309 determines, based on the litigant contracts in database 150, if reimbursement for litigation costs and expenses is due, i.e., if the litigant/indemnitee has an indemnification policy or bond relating to the judgment of a court case is entitled to recovery.

If the litigant/indemnitee is not entitled to recovery, the system 300 automatically generates a letter 313, and either mails it through the post, sends it private delivery service, or sends out an email to the litigant/indemnitee. Thereafter the process ends for the particular litigant/indemnitee, who may have purchased a contract for contingently reimbursing for litigation expenses. If the litigant/indemnitee is entitled to recovery the system 300 automatically determines in block 311, the amount of recovery, and thereafter generates an autopay event 315, and deposits a check or transfers funds in favor of the litigant/indemnitee.

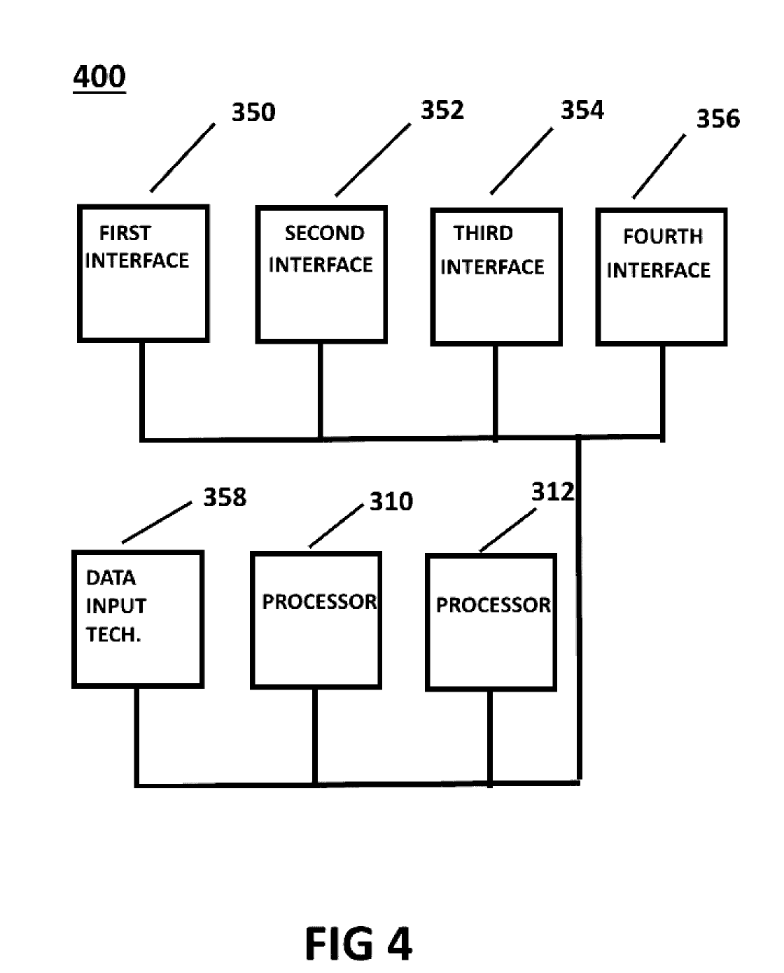

Turning to FIG. 4, another embodiment of the invention includes an apparatus 400 for processing data relating to reimbursement of litigation expenses associated with a litigation case which includes: (a) a first computer interface 350, associated with litigant contracts database 150 (See, FIG. 3), to post an indemnification contract terms and conditions, related to a contingency payment in the event of a claim event as defined by one of an indemnification policy or bond; (b) a second computer interface 352 for allowing the potential insurer or lender to adjust a premium or price respectively, for its indemnification contracts dependent on one of an increase or decrease in the contingency payment; (c) a third computer interface 354 for allowing for a potential indemnitee to view a posted cost or price, and request a contract be offered at the posted price; (d) a fourth computer interface 356 for allowing the lender to offer the contract to the potential indemnitee at said posted premium dependent on at least a specified recovery amount in the future was less than or equal to at least a fixed percentage of the expenses having been advanced over the premium, by an insured, towards cost and expenses, in a litigation, and the amount advanced was not completely unrecoverable from the litigation proceeds.

Turning to FIG. 4, the data input technology 358 previously described (see, FIG. 3) as receiving two related litigation documents from case management database, and determining if there is a change in the documents, such that the change indicates a status change in the case. A test 359 (see, FIG. 3) determines if there is a change, such change providing an electronic indicator 363, such as a signal or flag to logic block 361, that then allows the data pertaining to the case name, by way of example and not limitation, docket number or other identifying information to be compared in compared 303 to whether a like case resided in the litigant contracts database 150. If there is a match, then the process determines if the data represents that the lawsuit has terminated.

The apparatus 400 in one embodiment includes a processor 310 with an appropriate interface, that performs the comparator function 303 (see FIG. 3), as well as the test to determine if the lawsuit terminated 307, i.e. for determining if the litigation reached final judgment. An A Specific Integrated Circuit (ASIC) provides known outputs in response to known inputs to provide among other things, for the contingency payment may be utilized to perform the comparator function 303, and the related test 307.

If final judgement is rendered, then the apparatus 400 via processor 312, executes the function whether the litigant is entitled to recovery 309 (see, FIG. 303), and determining the amount of recovery 311, and generates letters 313 and generates autopay 315 regarding automatically paying an amount of money dependent on the contract.

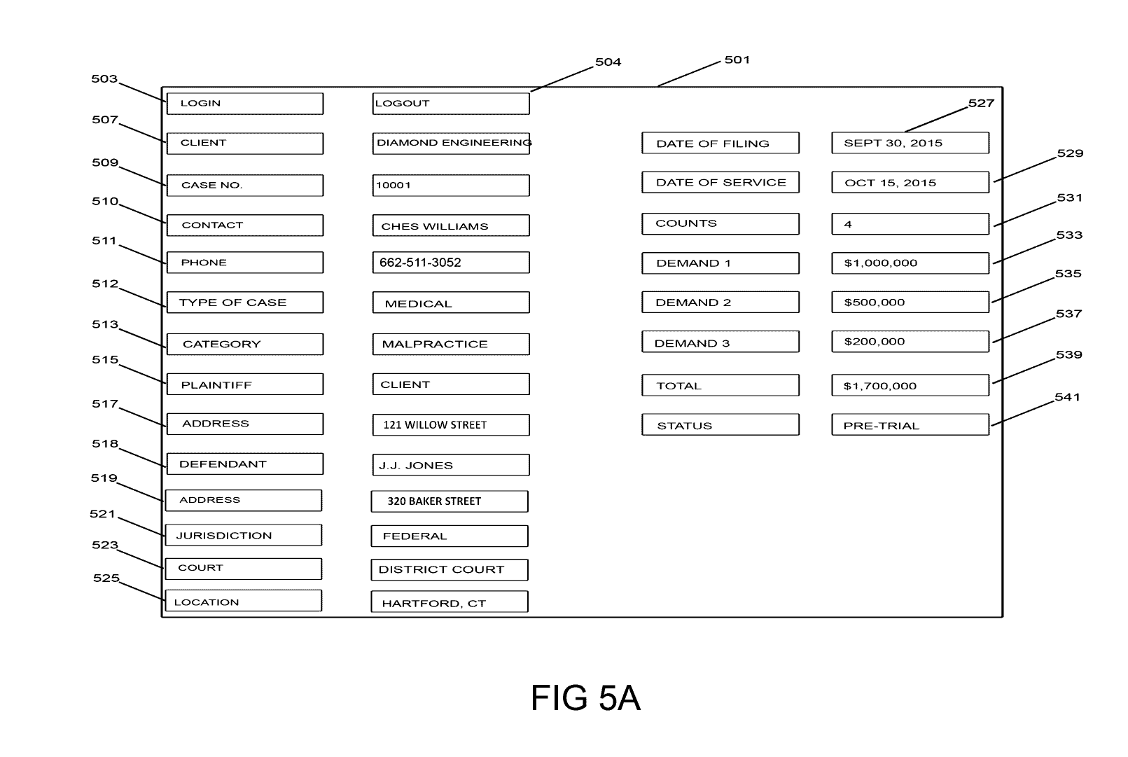

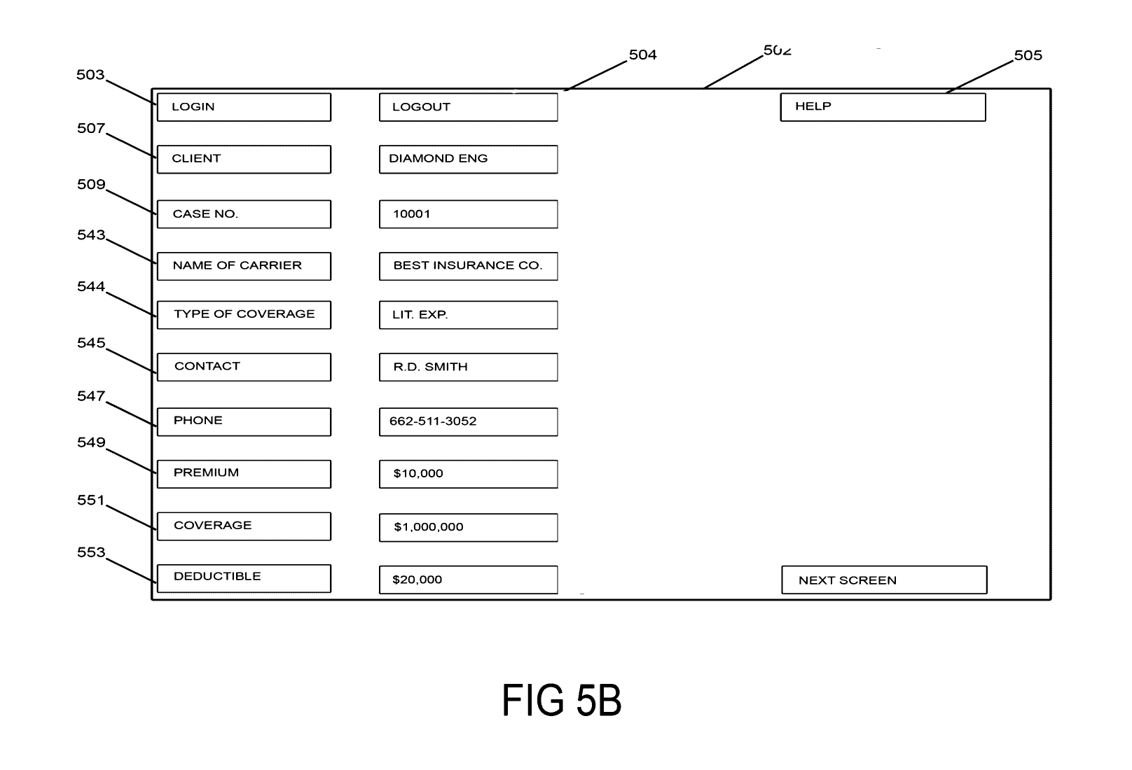

FIG. 5A and FIG. 5B illustrate a non limiting example of an application that serves as part of the statistical input data required by the process 200, as detailed in FIG. 2A, FIG. 2B, and the systems FIG. 1 and FIG. 3. FIG. 5A shows a GUI screen 501 of display 103 (FIG. 1) of an application wherein a non limiting example of images generated, such as a sub-windows, log-in 503, log-out 504, and help 505 allow a user to populate the information required to carry out the eventual indemnification of a litigant involved in a legal action that may exact costs and expenses during its prosecution or defense.

The log in screen 503 may in turn pull-up other screens to input username and passwords. Other sub-windows utilized in FIG. 5A are populated by a user inputting such items a client name 507, case number 509, contact 510, phone 511, type case 512, category 513, plaintiff 515, plaintiff address 517, defendant 518, defendant address 519, jurisdiction 521, court 523, location 525, date of filing 527, date of service 529, counts 531, demand 1, 533, demand 2 535, demand 537, total demand, 539 and status 541.

FIG. 5B, represents screen 502 of display 103 (FIG. 1) the information related to the indemnification coverage, such as the name of an insurance carrier 543, contact name 545, phone number 547, the insurance premium 549, coverage 551, the deductible 553 and allow user to navigate to other screens.

While specific embodiments of the invention have been described in detail, it will be appreciated by those skilled in the art that various modifications and alterations would be developed in the overall teachings of the disclosures. Accordingly, the particular arrangement discloses are meant to be illustrative only and not limited as to the scope of the invention which is to be given the full breadth of the appended claims and in any and all equivalents thereof.

I claim:

1. A system for processing data relating to insuring against litigation expenses comprises: (a) at least one computer processor; at least one memory; and computer program code stored in a computer readable storage medium executable by the at least one processor, having a graphical user interface configured to administer an indemnification contract related to one or more litigation cases; (b) a first storage device for storing a database that contains a plurality of indemnification contracts associated with one or more litigation cases; (c) a second storage device that contains a status of the one or more litigation databases of cases before state and federal courts; (d) a web crawler that searches the litigation databases to update a data input technology that monitors the one or more litigation cases before one or more state and federal courts; (e) wherein the database litigation technology produces an electronic indicator signal if a change in the litigation case status occurs; and (f) a comparator compares the database litigation case that produced the electronic indicator signal, to a litigant contracts database containing a related litigation case, such that if the comparison matches then, executable code determines if the litigation case has terminated and if a payment under the contract terms and conditions of a contingency payment related to a litigation is due.

2. The system of claim 1, wherein the comparator stores a flag in a register, which flag is read by the processor that executes computer code to test if an insured is entitled to a sum of money equivalent to the value of an insured interest.

3. The system of claim 1, wherein the crawler retrieves a case document, such that a test against documents previously stored in case management database results in a rejecting of a case document.

4. The system of claim 1, wherein the rejection results from no change in a parameter of interest.

5. The system of claim 1, wherein no rejection of the document is electronically indicated, and a comparison is performed between the document and a litigation document stored in a database.

6. The system of claim 1, wherein the indemnification contract includes one or more of a costs and expenses of litigation.

7. The system of claim 1, wherein the indemnification contract assures a recovery amount, provided at least a fixed percentage of funds had been advanced for litigation costs and expenses by a litigant over a stated amount, and that the amount advanced was unrecoverable out of litigation proceeds.

8. The system of claim 1, wherein one or a type of case, such as contract, negligence, tort, and one of a specific cause of action, including personal injury, wrongful death, premises liability, intellectual property infringement are in the data comprising the litigation cases stored in the first storage device.

9. A method of insuring against litigation expenses of a litigation case comprises the steps of (a) guiding a user through a series of graphical user interface queries to supply information to a database, including one or more of identifying: an insured, a type of litigation case, a range of economic damages, name of carrier, type of coverage; (b) storing the information in a database; (c) using the information to calculate a cost of indemnification coverage; (d) using the cost of the indemnification coverage to calculate a premium to be paid for the indemnification coverage; (e) creating an indemnification policy based upon risk factors; (f) web crawling to search litigation databases to update a data input technology that that monitors the one or more litigation cases in one or more state and federal courts; (g) comparing documents in the litigation case for electronically indicating a change in the litigation case status received by a database litigation file; (h) electronically comparing a database litigation file data to a litigant contracts database, such that if the comparison matches then, setting a flag, and utilizing the flag to execute code to determine if the litigation case has terminated and if a payment under the indemnification policy related to the litigation case is due.

10. The method of claim 9 further includes the step of determining if a contingency payment related to a litigation is due and providing that at least a fixed percentage of funds had been advanced by the indemnitee in accordance with the indemnification policy, towards cost and expenses in a lawsuit, and that the amount advanced was unrecoverable out of litigation proceeds, then making payment to the indemnitee.

11. The method of claim 9 further includes the step of including one or more type of case information, including one or more of: contract, negligence, tort, personal injury, wrongful death, premises liability, intellectual property infringement in the database of the litigation cases.

12. The method of claim 9 further including the step of executing computer code to transfer to the insured a sum of money equivalent to a stated amount in the indemnification contract.

13. A non-transitory computer-readable medium having stored thereon computer-readable instructions comprising computer code for: (a) guiding a user through a series of graphical user interface queries to supply information to a database, including one or more of identifying: an insured, a type of litigation case, a range of economic damages, name of carrier, type of coverage; (b) storing the information in a database; (c) using the information to calculate a cost of indemnification coverage; (d) using the cost of the indemnification coverage to calculate a premium to be paid for the indemnification coverage; (e) creating an indemnification policy based upon risk factors; (f) web crawling to search litigation databases to update a data input technology that that monitors the one or more litigation cases in one or more state and federal courts; (g) comparing documents in the litigation case for electronically indicating a change in the litigation case status received by a database litigation file; (h) electronically comparing a database litigation file data to a litigant contracts database, such that if the comparison matches then, setting a flag, and utilizing the flag to execute code to determine if the litigation case has terminated and if a payment under the indemnification policy related to the litigation case is due.
